(19) United States
(12) Patent Application Publication
(10) Pub. No.: US 2020/0112665 A1
(43) Pub. Date: Apr. 9, 2020

(54) IMAGE CAPTURING APPARATUS AND CONTROL METHOD THEREOF, AND NON-TRANSITORY STORAGE MEDIUM

(71) Applicant: CANON KABUSHIKI KAISHA, Tokyo (JP)

(72) Inventor: Akimitsu Yoshida, Tokyo (JP)

(21) Appl. No.: 16/590,696

(22) Filed: Oct. 2, 2019

(30) Foreign Application Priority Data
Oct. 3, 2018 (JP) 2018-188610

(51) Int. Cl. H04N 5/235; H04N 5/232; H04N 5/353

(52) U.S. Cl. CPC H04N 5/2353; H04N 5/23245; H04N 5/2351; H04N 5/3535; H04N 5/23212; H04N 5/23293

(57) ABSTRACT

An image capturing apparatus comprising: an image sensor; a display; and a controller that controls exposure timing of the image sensor and display timing of displaying an image read from the image sensor in the display. The controller controls to continuously read first images and second images, resolution of the first images and resolution of the second images being different from each other, controls the exposure timing so that intervals between first reference times during exposure periods of the first images and second reference times during exposure periods of the second images are substantially equal, and controls the display timing so that time from the first reference time until the first image is displayed in the display and time from the second reference time until the second image to be displayed in the display are substantially equal.

### BACKGROUND OF THE INVENTION

### Field of the Invention

The present invention relates to an image capturing apparatus and control method thereof, and a non-transitory storage medium.

### Description of the Related Art

In general, an image capturing apparatus such as a digital camera is provided with a so-called continuous shooting function for continuously acquiring still images. It is known that during the continuous shooting, live view (LV) images for live view and still images for recording, whose types are different from each other, are read out, and images are displayed in real time on a display such as a rear monitor provided in the image capturing apparatus and still images are record in parallel.

For example, a technique is known in which followability to a main subject at the time of focus detection is improved by displaying on a display device an LV image acquired from an image sensor while performing focus detection during continuous shooting. Japanese Patent Laid-Open No. 2015-144346 proposes a technique for switching between sequentially displaying images with different resolutions or displaying only high-resolution images on a display device. According to Japanese Patent Laid-Open No. 2015-144346, even during continuous shooting with a low frame rate, it is possible to increase the frame rate of the LV image and improve the followability to the main subject during framing.

The time required to acquire image data varies depending on the resolution of the image data to be acquired. In general, for an LV image whose main purpose is sequential display on a display unit, images are read out by thinning predetermined rows of effective pixels of an image sensor or adding pixel signals, and thus the resolution of these images is lower than that of a still image for recording.

Japanese Patent Laid-Open No. 2015-144346 does not consider the difference in time required to acquire image data when sequentially displaying image data with different resolutions. Therefore, in the technique proposed in Japanese Patent Laid-Open No. 2015-144346, the time taken from the start of imaging (exposure) to display on a display becomes uneven due to the difference in resolution, which may give the user a sense of incongruity. In addition, in the technique disclosed in Japanese Patent Laid-Open No. 2015-144346, exposure timing of a still image and exposure timing of an LV image are not taken into consideration, which causes variation in moving amount of a moving subject on a display screen at the time of shooting the subject and may give the user a sense of discomfort.

### SUMMARY OF THE INVENTION

The present invention has been made in consideration of the above situation, and mitigates a sense of discomfort given to a user in a case where images having different resolutions are continuously acquired and sequentially displayed.

According to the present invention, provided is an image capturing apparatus comprising: an image sensor; a display; and a controller that controls exposure timing of the image sensor and display timing of displaying an image read from the image sensor in the display, wherein the controller controls to continuously read first images and second images, resolution of the first images and resolution of the second images being different from each other, controls the exposure timing so that intervals between first reference times during exposure periods of the first images and second reference times during exposure periods of the second images are substantially equal, and controls the display timing so that time from the first reference time until the first image is displayed in the display and time from the second reference time until the second image to be displayed in the display are substantially equal.

Further, according to the present invention, provided is a method of controlling an image capturing apparatus having an image sensor and a display, the method comprising: continuously reading first images and second images, resolution of the first images and resolution of the second images being different from each other; sequentially displaying the first images and the second images in the display; controlling exposure timing so that intervals between first reference times during exposure periods of the first images and second reference times during exposure periods of the second images are substantially equal; and controlling the display timing so that time from the first reference time until the first image is displayed in the display and time from the second reference time until the second image to be displayed in the display are substantially equal.

Furthermore, according to the present invention, provided is a non-transitory storage medium readable by a computer, the storage medium storing a program that is executable by the computer, wherein the program includes program code for causing the computer to function as a controller of an image capturing apparatus having an image sensor and a display, wherein the controller controls to continuously read first images and second images, resolution of the first images and resolution of the second images being different from each other, controls exposure timing so that intervals between first reference times during exposure periods of the first images and second reference times during exposure periods of the second images are substantially equal, and controls display timing so that time from the first reference time until the first image is displayed in the display and time from the second reference time until the second image to be displayed in the display are substantially equal.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1A is a block diagram showing a schematic configuration of an image capturing system according to an embodiment of the present invention;

FIG. 1B is a diagram showing an example of a configuration of a part of pixels of an image sensor according to the embodiment;

FIGS. 2A and 2B are timing charts for explaining operations in a case of continuously shooting still images during live view display according to the embodiment;

FIG. 3 is a view for explaining delay of display in a case of continuously shooting still images during live view display according to the embodiment;

FIG. 4 is a flowchart for explaining a flow in a case of continuously shooting still images during live view display according to a first embodiment;

FIG. 5 is a flowchart for explaining a flow in a case of continuously shooting still images during live view display according to a second embodiment; and

FIGS. 6A and 6B are views showing a relationship between readout areas for an LV image and an AF image and a focus detection area according to the second embodiment.

### DESCRIPTION OF THE EMBODIMENTS

Exemplary embodiments of the present invention will be described in detail in accordance with the accompanying drawings.

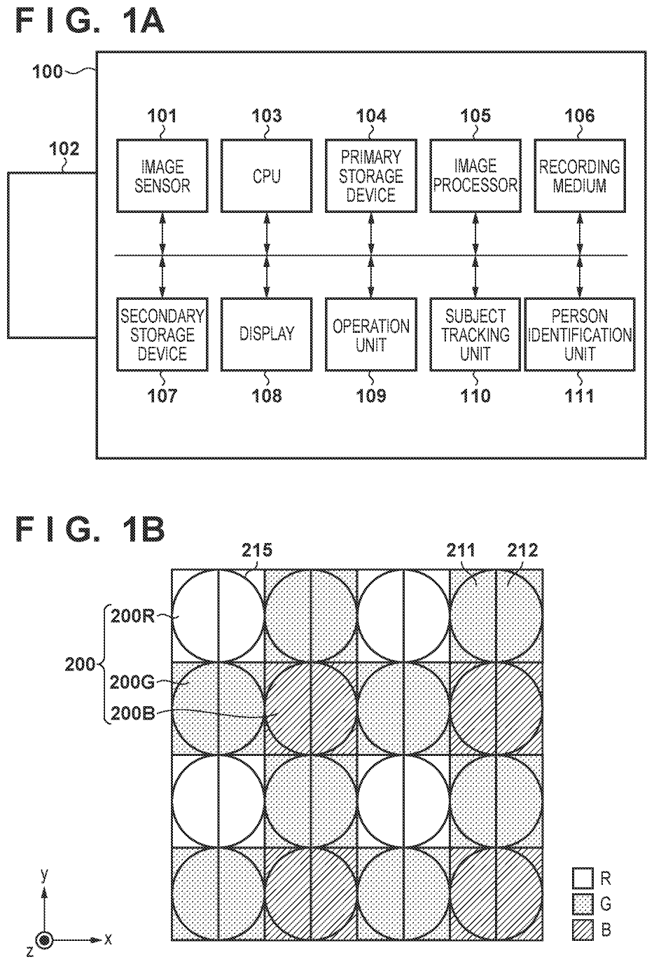

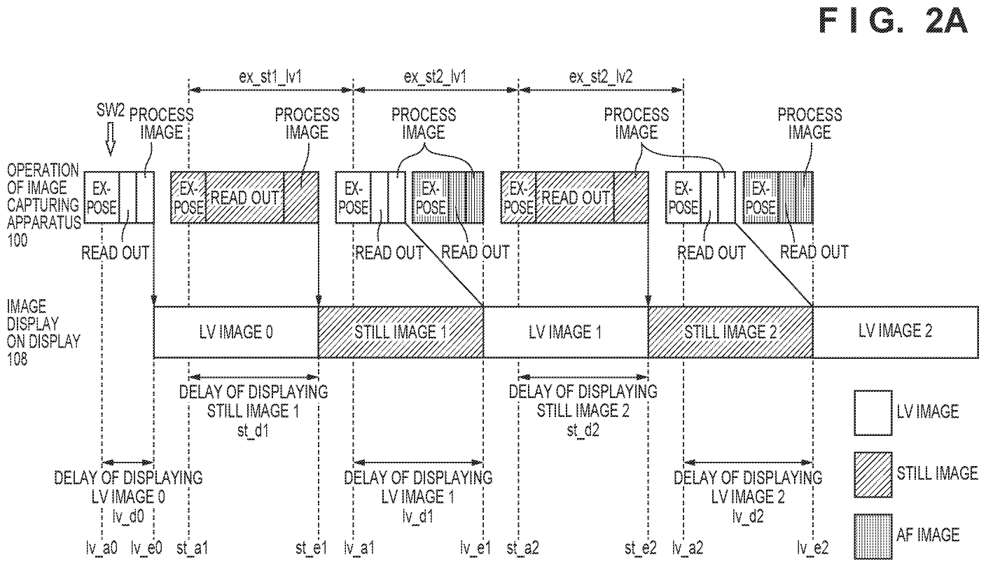

FIGS. 1A and 1B are block diagrams illustrating a schematic configuration of an image capturing system according to an embodiment of the present invention. The image capturing system in the present embodiment mainly includes an image capturing apparatus 100 and an optical system 102.

The optical system 102 includes an imaging lens group, a focus lens, a diaphragm, and the like, and is controlled by a CPU 103 described later. In this embodiment, the optical system 102 and the image capturing apparatus 100 are provided with mount portions corresponding to each other, and a so-called lens interchangeable image capturing apparatus in which the optical system 102 can be attached to and detached from the image capturing apparatus 100 will be described, however, the present invention is not limited thereto. For example, the image capturing apparatus 100 may be a so-called lens-integrated image capturing apparatus in which the optical system 102 is incorporated.

(Basic Configuration of Image Capturing Apparatus 100)

Next, each component of the image capturing apparatus 100 will be described. In FIG. 1A, the image capturing apparatus 100 includes a camera such as a digital camera or a digital video camera, and a portable device with a camera function such as a smartphone.

An image sensor 101 is a solid-state image sensor that converts incident light into an electrical signal. For example, a CCD or a CMOS image sensor can be used. The light flux of a subject passed through the optical system 102 and formed on the light receiving surface of the image sensor 101 is photoelectrically converted by the image sensor 101, and an image signal is generated.

In the following description, a case where images used for a live view image (hereinafter referred to as “LV images”) with a first resolution and still images with a second resolution higher than the first resolution are obtained using the image sensor 101, and the obtained images are displayed on a display 108 will be explained. Here, the above-described resolutions indicate the resolutions of the acquired images, and are not synonymous with a resolution of images displayed on the display 108. That is, the resolutions of the LV images and the still images when displayed on the display unit 108 are not necessarily different, and can be adjusted according to the resolution that the display 108 can express.

In this embodiment, since the number of pixels of the image sensor 101 that is read when acquiring an LV image is smaller than the effective number of pixels of a pixel portion of the image sensor 101 that is read when acquiring a still image, the resolution of LV images and the resolution of still images are different from each other. More specifically, an LV image is acquired by thinning out and/or adding predetermined pixels in the pixel portion constituting the image sensor 101 and reading out the charges accumulated in the corresponding pixels. In the present embodiment, LV images are acquired reading out a signal from the image sensor 101 while reading pixels in every predetermined number of lines. Further, the image sensor 101 includes pupil-divided phase difference pixels, and on-imaging plane phase difference AF of performing autofocus (AF) based on output data of the phase difference pixels is possible.

Here, the image sensor 101 will be briefly described. FIG. 1B is a diagram showing an example of the arrangement of pixels constituting the image sensor 101, and shows a range of 4 columns×4 rows of pixels or a range of 8 columns×4 rows of focus detection pixels.

A pixel group 200 consists of 2 columns×2 rows of pixels and is covered by a color filter of a plurality of colors, and a pixel 200R having R (red) spectral sensitivity is arranged at the upper left position, pixels 200G having G (green) spectral sensitivity are arranged at the upper right and lower left positions, and a pixel 200B having B (blue) spectral sensitivity is arranged at the lower right position. Furthermore, in the image sensor 101 of the present embodiment, each pixel holds a plurality of photoelectric conversion units (photodiodes) with respect to one microlens 215 in order to perform on-imaging plane phase difference focus detection. In this embodiment, it is assumed that each pixel is constituted by two photodiodes 211 and 212 arranged in 2 columns×1 row.

The image sensor 101 can acquire image signals and focusing signals by arranging a large number of pixel groups 200 consisting of 4 columns×4 rows of pixels (8 columns×4 rows of photodiodes) shown in FIG. 1B on its imaging surface.

In each pixel having such a configuration, light fluxes are separated by the microlens 215 and enter the photodiodes 211 and 212. Then, the signal (A+B signal) obtained by adding the signals from the two photodiodes 211 and 212 is used as an image signal, and the two signals (A signal and B signal) individually read out from the photodiodes 211 and 212 are used as focusing signals for an AF image which will be described later. That is, the phase difference AF can be performed by generating an A image by collecting the A signal from each pixel, generating a B image by collecting the B signal from each pixel, and obtaining a phase difference between the A image and the B image.

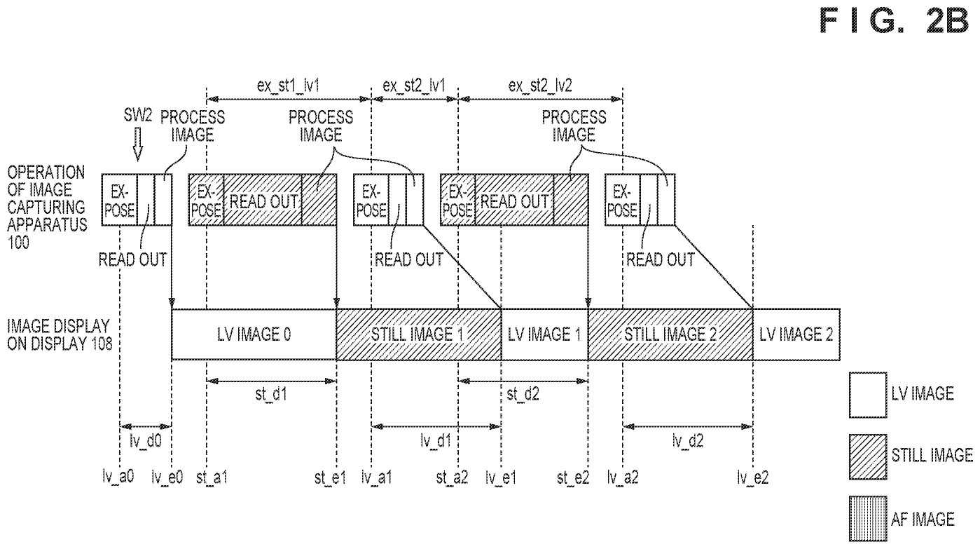

In the present embodiment, each pixel has two photodiodes 211 and 212 which correspond to one micro lens 215, however, the number of photodiodes is not limited to two, and may be more than two. Further, a plurality of pixels having different opening positions of the light receiving portions with respect to the microlenses 215 may be provided. That is, any configuration may be used as long as two signals for phase difference detection, such as A signal and B signal, can be obtained as a result. Further, the present invention is not limited to the configuration in which all the pixels have a plurality of photodiodes as shown in FIG. 2B, but the focus detection pixels may be discretely provided among normal pixels that constitute the image sensor 101.

The CPU 103 is a controller typified by a microprocessor for integrally controlling the image capturing apparatus 100, and controls each part of the image capturing apparatus 100 according to an input signal and a prestored program. In particular, in each embodiment to be described later, the CPU 103 performs display control in which still images and LV images are continuously displayed on the display 108 while switching between those images during continuous shooting of still images.

A primary storage device 104 is a volatile memory such as a RAM, for example, stores temporary data, and is used as a work area of the CPU 103. In addition, information stored in the primary storage device 104 is used by an image processor 105 and is recorded on a recording medium 106. A secondary storage device 107 is a non-volatile memory such as an EEPROM, for example. The secondary storage device 107 stores a program (firmware) for controlling the image capturing apparatus 100 and various setting information, and is used by the CPU 103. The recording medium 106 can record image data obtained by shooting and stored in the primary storage device 104. The recording medium 106 can be removed from the image capturing apparatus 100, like a semiconductor memory card, for example, and the recorded data can be read out by the personal computer by attaching the recording medium 106 to a personal computer or the like. Therefore, the image capturing apparatus 100 has an attachment/detachment mechanism and a read/write function for the recording medium 106.

The image processor 105 also has a function of performing image processing using information on a subject region in an image supplied from a subject tracking unit 110 described later, in addition to a function of performing image processing so-called development processing. The image processor 105 has a function of calculating an autofocus evaluation value (AF evaluation value) based on the focusing signals supplied from the image sensor 101. The CPU 103 can focus on the subject by driving a focus lens included in the optical system 102 in accordance with the calculated AF evaluation value.

The display 108 has a function as an electronic viewfinder, and displays a still image and a moving image obtained by capturing an image of a subject, and displays an operation GUI. The display 108 can also show a subject area including a subject to be tracked specified by the subject tracking unit 110 described later in a predetermined form (for example, a rectangular frame). Note that moving images that can be displayed on the display 108 include a so-called live view image which is realized by sequentially displaying images that are based on image signals acquired continuously in time. In the present embodiment, a still image shooting operation is executed in response to an instruction to start shooting preparation or shooting by the user during displaying a live view image.

An operation unit 109 is an input device group that receives a user's operation and transmits input information to the CPU 103. For example, the operation unit 109 is an input device using buttons, levers, a touch panel, or the like, or voice or line of sight. The operation unit 109 includes a release button which has a so-called two-stage switch configuration in which a switch SW1 (not shown) is turned on when the release button is half-pressed and a switch SW2 (not shown) is turned on when the release button is fully pressed. In the image capturing apparatus 100 of this embodiment, the start of a shooting preparation operation including a focus detection operation and a photometry operation is instructed by turning on the switch SW1, and the start of a still image shooting operation is instructed by turning on the switch SW2.

The subject tracking unit 110 detects and tracks a subject included in continuous image signals sequentially supplied in time series from the image processor 105, for example, by continuously shooting the subject. Specifically, the subject tracking unit 110 tracks a predetermined subject by comparing temporally continuous image signals supplied from the image processor 105 and tracking, for example, partial regions in which pixel patterns and histogram distributions between image signals are similar. The predetermined subject may be, for example, a subject specified by a user's manual operation and a subject that is automatically detected in accordance with a shooting condition, a shooting mode, or the like, in a predetermined subject region such as or a human face region. It should be noted that any method may be employed as the subject region detection method, and the present invention is not limited by the subject region detection method. For example, a method using learning represented by a neural network and, in a case of detecting a face region, a method of extracting a part having a feature in a physical shape such as an eye or nose from an image region by template matching are known. Further, there is a method of recording an edge pattern for detecting a predetermined subject in an image and detecting the subject by pattern matching between the edge pattern and an image signal.

A person identification unit 111 compares the subject that the subject tracking unit 110 has determined as a person's face with person identification data registered in the secondary storage device 107 in advance, and determines whether or not a face image of the detected person matches a face image of a registered person.

### First Embodiment

Next, the operation of the image capturing apparatus 100 during continuous shooting in the first embodiment will be described with reference to FIGS. 2A and 2B. FIG. 2A is a timing chart in a case where the delay time between an exposure period and display start timing of an LV image and the delay time between an exposure period and display start timing of a still image are controlled to be the same, and it is shown so as to facilitate to see the difference from the control shown in FIG. 2B. FIG. 2B is a timing chart in a case where the delay time between an exposure period and display start timing of an LV image and the delay time between an exposure period and display start timing of a still image are controlled to be the same and the intervals between the exposure periods are controlled to be equal.

When the start of live view display is instructed from the operation unit 109, the CPU 103 controls the optical system 102 to perform exposure process of the image sensor 101. After performing the exposure process for a predetermined period, the CPU 103 reads an LV image signal from the image sensor 101 at the first resolution determined in advance, and stores the read image signal in the primary storage device 104. The image signal stored in the primary storage device 104 is subjected to image processes by the image processor 105, and the processed image signal (image data) is stored again in the primary storage device 104. Further, the CPU 103 displays an image on the display 108 immediately after the generation of the image data is completed. The image data is also sent to the subject tracking unit 110, and subject tracking process is executed. Thereafter, if there is no instruction from the operation unit 109, the above processes are repeatedly executed (live view shooting state).

Here, the delay lv_dn of displaying the n-th (n≥1) LV image n can be expressed as lv_dn=lv_en−lv_an. Note that lv_an represents a central time (exposure center of gravity) from the start of exposure to the end of exposure of the LV image n, and lv_en represents a time at which display 108 starts displaying image data corresponding to the LV image n.

When the switch SW2 is turned on during the live view is displayed, still image shooting is started. In still image shooting, a series of processes of exposure, read out, image processing, and subject tracking are performed under the control of the CPU 103 as in the case of shooting an LV image, and image data is displayed on the display 108. The delay st_dn of displaying the nth still image n can be expressed by st_dn=st_en−st an, as in the case of the LV image. Note that st an represents the center time (exposure center of gravity) from the start of exposure to the end of exposure of the still image n, and st_en represents the time at which display 108 starts displaying image data corresponding to the still image n.

Further, the distance ex_stn_lvn between the exposure centers of gravity of the LV image n and the still image n can be expressed as ex_stn_lvn=lv_an−st an. Similarly, the distance ex_st(n+1)_lvn between the exposure centers of gravity of the still image (n+1) and the LV image n can be expressed as ex_st(n+1)_lvn=st_a(n+1)−lv_an.

In the example shown in FIG. 2A, after the switch SW2 is turned on, the CPU 103 controls the display of LV image data on the display 108 so that the delay lv_dn of displaying an LV image and the delay st_dn of displaying a still image become lv_dn=st_dn. By controlling the delays of displaying a LV image and a still image to be equal, there is an advantage that a photographer can easily frame the subject to the target position on the screen. However, since the exposure center of gravity lv_an of an LV image and the exposure center of gravity st an of a still image are not equally spaced (ex_stn_lvn≠ex_st(n+1)_lvn), the display may become unnatural in a case where the subject is a moving body.

On the other hand, in FIG. 2B, in addition to controlling the delay of display to be lv_dn=st_dn, the intervals of the exposure centers of gravity are controlled so that ex_stn_lvn=ex_st(n+1)_lvn. Usually, since the processing time of an LV image is shorter than that of a still image, after capturing an LV image, the timing of starting capturing still images (exposure timing) is delayed, thereby controlling intervals between the centers of gravity of an LV image and a still image to become substantially equal. Further, an image that is not displayed on the display 108 is captured in a time generated by delaying the timing of starting shooting a still image. The details of the processing at the time of capturing such image will be described later.

By controlling the delay of display and the exposure interval of LV images and still images to be substantially equal in this way, cycles of the exposure timing and display timing of images displayed on the display 108 become constant, so it becomes easier for the photographer to frame a subject at the target position on the screen.

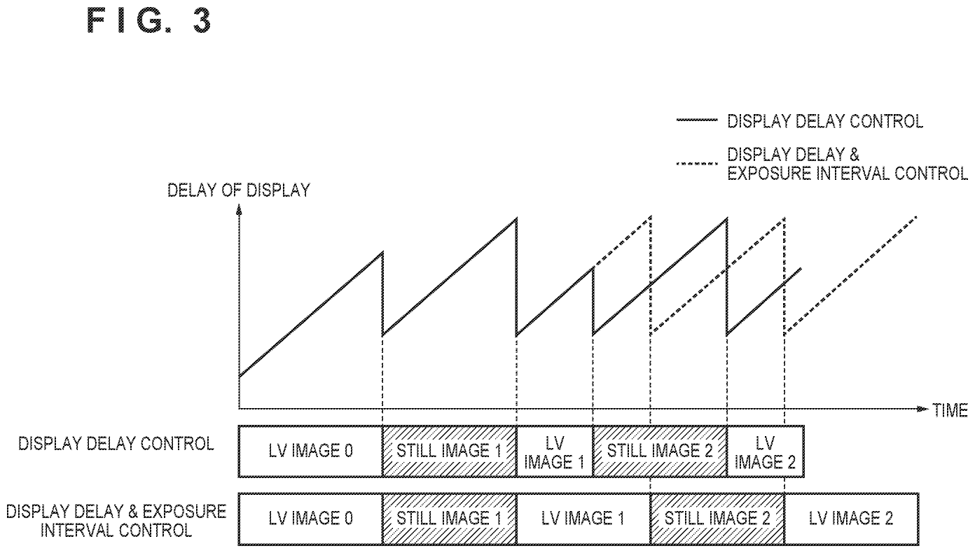

FIG. 3 shows the delay of display in a case where only the delay of display is controlled as shown in FIG. 2A and in a case where the delay of display and the exposure interval are controlled as shown in FIG. 2B. It can be seen that in the case where the delay of display and the exposure interval are controlled together, the update period of images on the display 108 is more stable and the delay of display also changes more stably comparing to the case where only the delay of display is controlled.

Thereafter, when the switch SW2 is turned on, the processing for still image and the processing for live view are repeated as shown in FIG. 2B. Note that the above-described control can be realized by the CPU 103 controlling the image sensor 101 and the optical system 102.

In FIG. 2B, the control is performed so that the intervals between the exposure centers of gravity of the LV images and the exposure centers of gravity of the still images are constant, but the present invention is limited to the exposure center of gravity. For example, the intervals between the exposure start timings of LV images and the exposure start timings of still images may be controlled to be constant. In other words, control should be made so that intervals between reference times at a predetermined timing of the exposure periods may be constant.

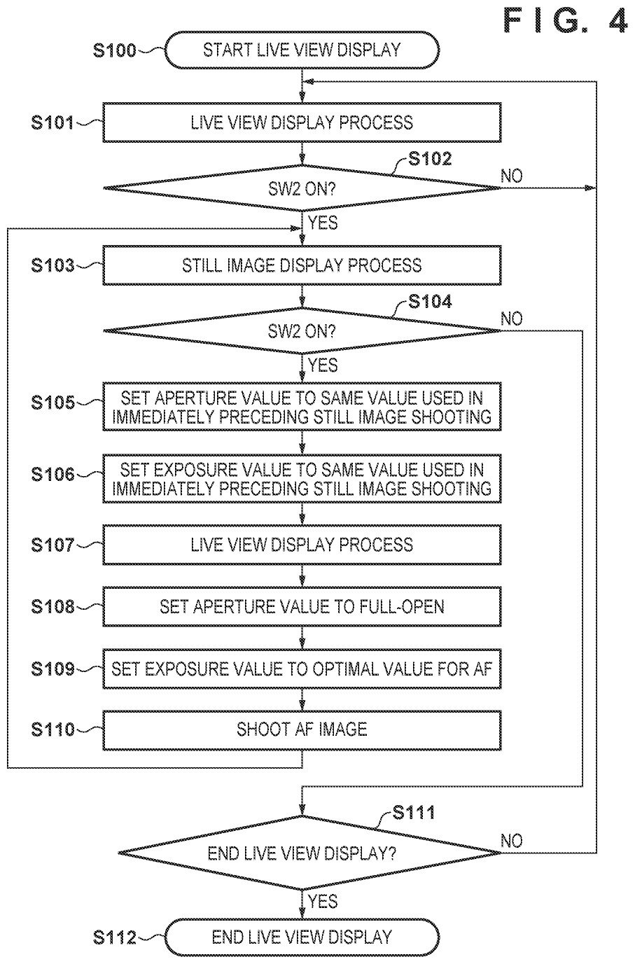

Next, a flow in a case of performing continuous shooting of still images while performing live view display in the first embodiment will be described with reference to FIG. 4. The live view display is started, for example, when shooting processing is selected by the operation unit 109 or when the live view display is turned on. Further, in this example, it is assumed that a still image continuous shooting mode is set.

After live view display is started in step S100, in step S101, the CPU 103 controls to perform live view display process comprised of a series of processes which include exposure of the image sensor 101 for a predetermined period, readout of an LV image, various image processes on the LV image performed by the image processor 105, and display of the LV image on the display 108. Next, in step S102, the CPU 103 determines whether the switch SW2 is turned on. If the switch SW2 is OFF, the process returns to step S101 and the above-described live view display process is continued.

On the other hand, if the switch SW2 is ON in step S102, the process proceeds to step S103, and still image display process is performed. Here, similarly to the live view display process, a series of processes comprised of exposure of the image sensor 101 for a predetermined period, readout of a still image, various image processes on the still image performed by the image processor 105, and display of the still image on the display 108 are performed. The still image obtained here is processed as a recording image by the image processor 105 and then recorded in the recording medium 106. After the still image display processes, in step S104, the CPU 103 determines whether the switch SW2 is still ON. If the switch SW2 is OFF, the process proceeds to step S111.

If the switch SW2 is ON, the process proceeds to step S105, and the CPU 103 sets the aperture value used when the previous still image was captured in step S103 to the diaphragm included in the optical system 102. In the present embodiment, since the LV images and the still images are alternately displayed during continuous shooting of still images, the aperture value is set as described above for the sake of preventing peripheral dimming and change in depth of field due to the change in aperture value, which gives the user a sense of incongruity. Next, in step S106, the CPU 103 controls the image sensor 101 and the image processor 105 so that the exposure (brightness) is the same as that of the still image taken immediately before in step S103, and the live view display process is performed in step S107 as in step S101.

Next, in step S108, the CPU 103 sets the aperture included in the optical system 102 to full-open aperture, and in step S109, the CPU 103 sets the optimal exposure to obtain an AF evaluation value. If the brightness of the area from which the AF evaluation value is obtained is over or under compared to the brightness of the entire screen, the reliability of the AF evaluation value obtained from an image shot with the optimal exposure determined from the brightness of the entire screen may be low. Further, in a case where the user intentionally corrects the exposure, there is a possibility that the reliability of the AF evaluation value becomes low. As described above, the optimum exposure for obtaining the AF evaluation value does not necessarily match the exposure at the time of shooting a still image.

Next, in step S110, the CPU 103 acquires an AF image under the conditions set in steps S108 and S109. Note that the AF image acquired in step S110 is shot under different exposure conditions from those for the still image, and thus is not displayed on the display 108. This is because displaying an image shot under different exposure conditions gives the user a sense of discomfort. The CPU 103 calculates an AF evaluation value from the AF image acquired in step S110, and drives the focus lens included in the optical system 102. In step S111, it is determined whether or not there is an instruction to end the live view display from the operation unit 109. If there is no instruction to end the live view display, the process proceeds to step S101, and the live view display process is continued, and if there is an instruction to end the live view display, the live view display is ended in step S112.

In FIG. 4, the AF image is shot once. However, a plurality of AF images may be shot as long as the exposure timings of the still images and the LV images are equally spaced.

In the first embodiment, the AF image is shot between the LV image and the still image. However, the AF image is not necessarily acquired. In this case, for example, the focus state may be detected based on at least one of the LV image and the still image.

Furthermore, the image shot between the LV image and the still image is not limited to the AF image, and an image for any purpose may be shot as long as the exposure timings of the LV images and the still images can be kept at regular intervals.

### Second Embodiment

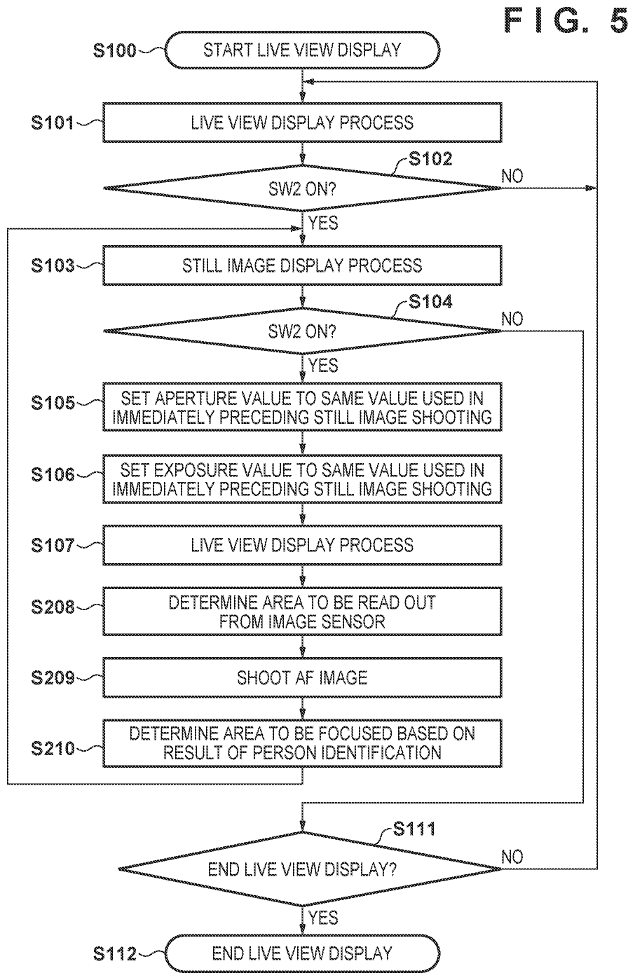

Next, with reference to FIG. 5, a flow in the case of performing continuous shooting of still images while performing live view display in the second embodiment will be described. Note that the processes of steps S100 to S107 is the same as the processes described with reference to FIG. 4 in the first embodiment, and thus description thereof is omitted here.

After the live view display process is performed with the same aperture value and exposure value as those of the still image in step S107, an area (partial area) to be read from the image sensor 101 is determined based on a subject tracking result of the subject tracking unit 110 in step S208. In step S209, the CPU 103 reads the area determined in step S208 from the image sensor 101 without thinning out, and acquires an AF image. Since the LV image captured in the live view display process is read out from the image sensor 101 by reading pixels in every predetermined number of lines, the spatial resolution of the region of interest is higher in the AF image. In step S210, the person identification unit 111 determines whether the subject determined by the subject tracking unit 110 as a person's face matches any of face images of people registered in advance in the secondary storage device 107. A region to be focused is determined based on the determination result of the person identification unit 111, and the process proceeds to step S211. The processes in steps S111 and S112 are the same as those in the first embodiment.

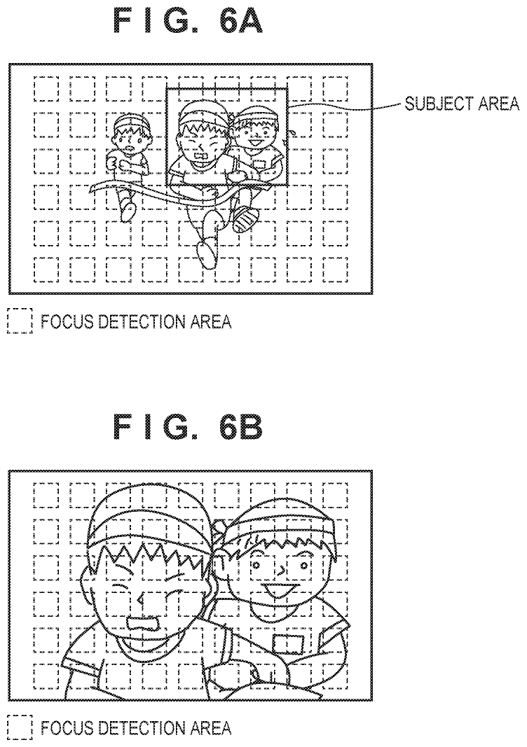

FIGS. 6A and 6B are diagrams showing the relationship between the readout areas for the LV image and for the AF image and the focus detection area in the processes of steps S107 to S210. FIG. 6A shows an LV image, which is an image obtained by reading out pixels of every predetermined number of rows and every predetermined number of columns from the entire image sensor 101. Each of rectangular areas represents a focus detection area and the focus detection areas are arranged uniformly over the entire screen. In this case, a perspective conflict occurs in which a plurality of subjects with different distances are included in one focus detection area, and the CPU 103 may not be able to acquire an AF evaluation value correctly.

On the other hand, in the second embodiment, the AF image is read from the image sensor 101 around the area determined by the subject tracking unit 110 as including the subject. FIG. 6B shows an AF image, and even if a focus detection area similar to that of the LV image is set, the possibility of perspective conflict is reduced. Furthermore, since the spatial resolution of the predetermined area is improved, accuracy of the person identification by the person identification unit 111 is also improved.

According to the second embodiment as described above, accuracy of focus detection and accuracy of person identification can be improved in addition to the same effects as those of the first embodiment.

In the embodiments, the configuration in which the LV images and the still images are alternately displayed has been exemplarily described, but a configuration in which a plurality of LV images are displayed between two still images may be employed. That is, the display order of the LV images and the still images is not necessarily alternate, and the present invention can be applied to a configuration in which the LV images and the still images are continuously displayed with regularity.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-188610, filed on Oct. 3, 2018 which is hereby incorporated by reference herein in its entirety.

What is claimed is:

1. An image capturing apparatus comprising:
an image sensor;
a display; and
a controller that controls exposure timing of the image sensor and display timing of displaying an image read from the image sensor in the display,
wherein the controller
controls to continuously read first images and second images, resolution of the first images and resolution of the second images being different from each other,
controls the exposure timing so that intervals between first reference times during exposure periods of the first images and second reference times during exposure periods of the second images are substantially equal, and
controls the display timing so that time from the first reference time until the first image is displayed in the display and time from the second reference time until the second image to be displayed in the display are substantially equal.

2. The image capturing apparatus according to claim 1, wherein the resolution of the first images is lower than the resolution of the second images, and
the controller controls the image sensor so that a third image is read during a period after the first image is read before the second image is read.

3. The image capturing apparatus according to claim 2, wherein resolution of the third image is lower than the resolution of the second images.

4. The image capturing apparatus according to claim 2 further comprising a detector that detects a predetermined subject based on at least one of the first images and the second images,
wherein the controller read the third image from an area of the image sensor corresponding to a partial region of the first image or the second image including the subject detected by the detector.

5. The image capturing apparatus according to claim 2, wherein a focus state is detected based on the third image.

6. The image capturing apparatus according to claim 2, wherein the controller further
controls an aperture value of the first image to a same aperture value of the second image which is read immediately before the first image, and
determines an aperture value of the third image regardless of the aperture value of the second image.

7. The image capturing apparatus according to claim 2, wherein the controller further
controls an exposure value of the first image to a same exposure value of the second image which is read immediately before the first image, and
determines an exposure value of the third image regardless of the exposure value of the second image.

8. The image capturing apparatus according to claim 2, wherein the third image is not displayed in the display.

9. The image capturing apparatus according to claim 1, wherein the first reference time and the second reference time represent center of each exposure period.

10. The image capturing apparatus according to claim 1, wherein the second images are images for recording.

11. The image capturing apparatus according to claim 10, wherein the first images are images not for recording,
in a case where an instruction of continuously reading and recording the second images while continuously reading and displaying the first images, the controller controls to alternately read the first images and the second images.

12. A method of controlling an image capturing apparatus having an image sensor and a display, the method comprising:
continuously reading first images and second images, resolution of the first images and resolution of the second images being different from each other;
sequentially displaying the first images and the second images in the display;
controlling exposure timing so that intervals between first reference times during exposure periods of the first images and second reference times during exposure periods of the second images are substantially equal; and
controlling the display timing so that time from the first reference time until the first image is displayed in the display and time from the second reference time until the second image to be displayed in the display are substantially equal.

13. A non-transitory storage medium readable by a computer, the storage medium storing a program that is executable by the computer, wherein the program includes program code for causing the computer to function as a controller of an image capturing apparatus having an image sensor and a display, wherein the controller
controls to continuously read first images and second images, resolution of the first images and resolution of the second images being different from each other,
controls exposure timing so that intervals between first reference times during exposure periods of the first images and second reference times during exposure periods of the second images are substantially equal, and
controls display timing so that time from the first reference time until the first image is displayed in the display and time from the second reference time until the second image to be displayed in the display are substantially equal.
